(19) United States
(12) Patent Application Publication
(10) Pub. No.: US 2026/0202829 A1
(43) Pub. Date: Jul. 16, 2026

(54) METHOD AND APPARATUS WITH PROCESS RECIPE MANAGEMENT

(71) Applicant: Samsung Electronics Co., Ltd., Suwon-si (KR)

(72) Inventors: Jiwon YEOM, Suwon-si (KR); Jeong-Hoon PARK, Suwon-si (KR); Kyungeun BYUN, Suwon-si (KR); Alum JUNG, Suwon-si (KR)

(73) Assignee: Samsung Electronics Co., Ltd., Suwon-si (KR)

(21) Appl. No.: 19/260,408

(22) Filed: Jul. 4, 2025

(30) Foreign Application Priority Data
Jan. 15, 2025 (KR) 10-2025-0006222

(51) Int. Cl. G05B 19/418

(52) U.S. Cl. CPC G05B 19/41865; G05B 19/4184

(57) ABSTRACT

A method of managing a process recipe of a production process is performed by a computing device and the method includes: acquiring a process recipe, wherein the process recipe includes process steps that express respective steps of the production process independent of any individual equipment; converting a process step, among the process steps, to an equipment step corresponding to an individual equipment, wherein the converting is based on mapping information corresponding to the process recipe, and wherein the equipment step expresses the process step with reference to the individual equipment; and storing the equipment step in association with the individual equipment.

### CROSS-REFERENCE TO RELATED APPLICATIONS

This application claims the benefit under 35 USC § 119(a) of Korean Patent Application No. 10-2025-0006222, filed on Jan. 15, 2025, in the Korean Intellectual Property Office, the entire disclosure of which is incorporated herein by reference for all purposes.

### BACKGROUND

### 1. Field

The following description relates to a method and an apparatus with process recipe management.

### 2. Description of Related Art

A process recipe is a data set that defines the parameters and sequences required to control each step in a manufacturing process or chemical process. Execution of a process recipe may require a variety of equipment and tools, and setting values and conditions for each step may be precisely controlled for each piece of equipment to ensure that each step of the process is executed accurately on various equipment. A process recipe may be written according to production requirements of a specific product and may play a key role in securing production efficiency and quality. To manage such process recipes, it may be helpful to maintain synchronization between equipment while also being flexible enough to immediately reflect changes in process conditions. Therefore, it may be beneficial to develop a technique to automate a repetitive feedback process of updating a process recipe based on an execution result and executing the updated process recipe on individual equipment.

### SUMMARY

The following examples may provide a technique for generating, modifying, and managing process recipes that are not dependent on individual equipment by converting each step of a process recipe to a step of individual equipment.

However, the technical aspects are not limited to the aforementioned aspect, and other technical aspects may be present.

In one general aspect, a method of managing a process recipe of a production process is performed by a computing device and the method includes: acquiring a process recipe, wherein the process recipe includes process steps that express respective steps of the production process independent of any individual equipment; converting a process step, among the process steps, to an equipment step corresponding to an individual equipment, wherein the converting is based on mapping information corresponding to the process recipe, and wherein the equipment step expresses the process step with reference to the individual equipment; and storing the equipment step in association with the individual equipment.

The process recipe may be a chemical vapor deposition (CVD) process recipe.

The converting may include converting an action included in the process step to an equipment action corresponding to the individual equipment, and the converting may be based on the mapping information corresponding to the process recipe.

The converting may include converting a parameter included in the process step based on parameter conversion logic corresponding to the individual equipment included in the mapping information.

The method may further include: receiving mapping information of the process step of the process recipe and the equipment step of the individual equipment; determining a validity of the mapping information based on a specification of the individual equipment; and updating the mapping information based on the determination of the validity.

The updating of the mapping information may include adjusting parameter conversion logic included in the mapping information based on the specification of the individual equipment.

The updating of the mapping information may include: determining a constraint condition of a parameter based on the specification of the individual equipment; and adjusting parameter conversion logic included in the mapping information based on the constraint condition.

The equipment step may be performed in the individual equipment.

The method may further include: outputting an execution result of the converted step of the individual equipment.

The method may further include: updating the process recipe based on the execution result of the equipment step of the individual equipment.

The acquiring of the process recipe may include receiving an input of the process recipe from a user.

The process recipe may be generated by a generative model.

In another general aspect, a non-transitory computer-readable storage medium stores instructions that, when executed by one or more processors, cause the one or more processors to: acquire a process recipe of an industrial process having steps, the process recipe including process steps of the respective steps, wherein each process step includes a parameter of the corresponding step; convert a process step, among the process steps, to a first equipment step corresponding to a first individual equipment, wherein the converting is based on first mapping information mapping the first process step to the first individual equipment, and wherein the converting includes converting the parameter of the process step to a first parameter that is specific to the first individual piece of equipment; convert the process step to a second equipment step corresponding to a second individual equipment, wherein the converting is based on second mapping information mapping the first process step to the second individual equipment, and wherein the converting includes converting the parameter of the process step to a second parameter that is specific to the second individual piece of equipment and store the first and second equipment steps in correspondence with the first and second individual equipment, respectively.

In another general aspect, an electronic device includes: one or more processors; and a memory storing instructions that, when executed by the one or more processors, cause the electronic device to: acquire a process recipe, wherein the process recipe includes process steps that express respective steps of a manufacturing process independent of any individual equipment; convert a process step, among the process steps, to an equipment step corresponding to an individual equipment based on mapping information corresponding to the process recipe, and wherein the equipment step expresses the process step with reference to the individual equipment; and store the equipment step in association with the individual equipment.

The process recipe may be a CVD process recipe.

The converting may include converting an action included in the process step to an equipment action corresponding to the individual equipment, and the converting may be based on the mapping information corresponding to the process recipe.

The converting may include converting a parameter included in the process step based on parameter conversion logic corresponding to the individual equipment included in the mapping information.

The instructions may be further configured to cause the electronic device to: receive mapping information of the process step of the process recipe and the equipment step of the individual equipment; determine a validity of the mapping information based on a specification of the individual equipment; and update the mapping information based on the determination of the validity.

The updating of the mapping information may include adjusting parameter conversion logic included in the mapping information based on the specification of the individual equipment.

The updating of the mapping information may include: determining a constraint condition of a parameter based on the specification of the individual equipment; and adjusting parameter conversion logic included in the mapping information based on the constraint condition.

### BRIEF DESCRIPTION OF THE DRAWINGS

FIG. 1 illustrates an example of a method of managing a process recipe, according to one or more embodiments.

FIG. 2 illustrates an example of a generalized chemical vapor deposition (CVD) process, according to one or more embodiments.

FIG. 3 illustrates an example of mapping information, according to one or more embodiments.

FIG. 4 illustrates an example of a system for managing a process recipe, according to one or more embodiments.

FIG. 5 illustrates an example of an operation of acquiring a process recipe, according to one or more embodiments.

FIG. 6 illustrates an example of a process of building a mapping information database (DB), according to one or more embodiments.

FIGS. 7A and 7B illustrate an example of a screen of a user interface, according to one or more embodiments.

FIG. 8 illustrates an example of a configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

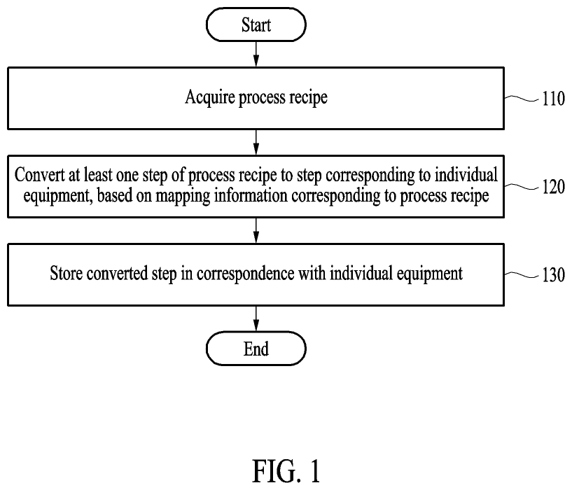

FIG. 1 illustrates an example of a method of managing a process recipe, according to one or more embodiments.

The method of managing a process recipe may be performed by one or more processors of an electronic device. A specific hardware configuration of an electronic device that performs the method of managing a process recipe is described below. The electronic device that performs the methods of managing a process recipe may be briefly referred to as the “electronic device.”

Referring to FIG. 1, the method of managing a process recipe may include an operation 110 of acquiring a process recipe.

A process recipe may be a document or guideline that defines a flow of steps, materials to be used, process conditions, and/or tool and equipment settings of a task that is performed to produce a product or part. For example, a process recipe may include an action and a parameter of each step of a process. An action at a particular step of a process may be a type of task performed at that step, which may include, for example, material injection, growth, cleaning, or the like. A parameter of a particular step of a process may be a condition that is to be achieved/satisfied for performing the action of that step, which may include, for example, ramp time, hold time, pressure, temperature, amount of material injected, or the like. A process recipe may be embodied in various forms, for example, in a structured markup language form (e.g., compliant to a relevant schema) or in a standardized form such as the ANSI/ISA-88 Batch Control standard.

A process recipe, as described herein, is an abstract (i.e., general or common) description of a process. Process recipes may be in text form and may be configured to conform to a simple language (e.g., one with logic semantics, syntactic and lexical rules, etc.). Process recipes are equipment-neutral, in that they generally do not have dependencies or recognition of specific pieces of equipment. That is, they describe a process in terms that are not specific to particular pieces of equipment. The process described by a process recipe may be carried out by one or more pieces of individual equipment. For example, some steps of a generalized process recipe may be executed on first equipment, and other steps of the generalized process recipe may be executed on second equipment. As described herein, a common/abstract process recipe may be converted to equipment-specific process recipes (also referred to herein as “equipment recipes”), which can be parsed and executed by the pieces of equipment to carry out the process described by the common process recipe.

As noted, the process recipe acquired in operation 110 may be a form of generalized process recipe. That is, a process recipe is a generalized form of recipe that is defined so that the process recipe is not dependent on a particular piece of process equipment, and may be a process procedure in which the actions and parameters of each essential step(s) of the process are expressed in standardized terms regardless of the equipment. As described below, each step of a generalized process recipe may be converted to a corresponding step equipment-specific that uses an individual equipment that executes that step. Going forward “process recipe” will be used to refer to an abstract (common, standard, or general) process description, and “equipment recipe” will be used to refer a recipe description that is specific to a piece of equipment (e.g., specific to a make and/or model of equipment). As described herein, a process recipe may be converted into multiple respectively corresponding equipment recipes, each specific to a corresponding piece of equipment. Similarly, “process step” (or “process action”) will be used to refer to the steps/actions of a process recipe, and “equipment step” (or “equipment action”) will be used to refer to the steps/actions of an equipment recipe.

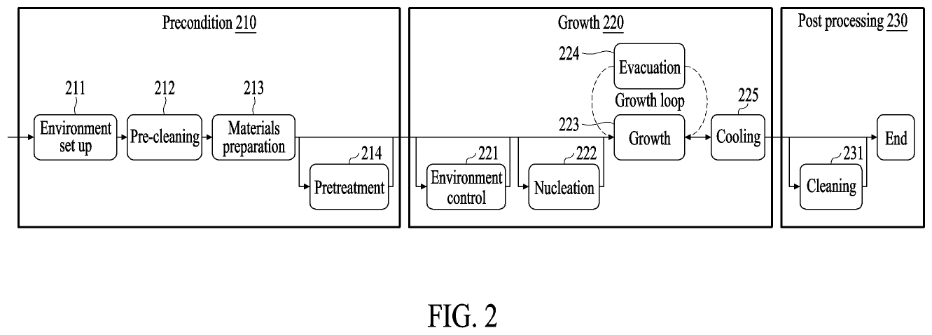

As an example, the process recipe may include a chemical vapor deposition (CVD) process recipe, which is a process of forming a solid thin film on a surface of a substrate by reacting a gaseous chemical substance. Steps of the CVD process are mentioned with reference to FIG. 2.

FIG. 2 illustrates an example of a generalized CVD process, according to one or more embodiments. A generalized CVD process is a CVD process that is expressed independent of process equipment. Referring to FIG. 2, the generalized CVD process may be divided into a precondition process 210 for preconditioning for performance of a growth process 200, a growth process 220, in which actual growth is performed, and a post processing process 230 performed after the growth process 220 is completed. The precondition process 210 may include an environment set up step 211 for process progression, a pre-cleaning step 212, a materials preparation step 213 (including material vaporization), and a pretreatment step 214. The growth process 220 may include an environment control step 221 and a nucleation step 222 that control the environment in which the growth reaction occurs. Additionally, the growth process 220 may include a growth loop in which a growth step 223 and an evacuation (or gas purge) step 224 are repeated, followed by a cooling step 225. The post processing process 230 may include a cleaning step 231.

When the process recipe acquired in operation 110 is a CVD process recipe, the process recipe may include information indicating actions of steps, such as the environment set up step, pre-cleaning step, materials preparation step, pretreatment step, growth step, cooling step, and cleaning step included in the CVD process, and information indicating parameters (e.g., ramp time, hold time, pressure, temperature, amount of material injected, and the like) for executing the actions of the steps.

In an example, the operation 110 of acquiring the process recipe may include receiving an input of the process recipe from a user. The process recipe may be acquired from the user's input. For example, a process recipe may be input by the user through a user interface for process recipe design, selection of the process recipe from a library of process recipes, etc. The user interface for process recipe design is described below.

In an example, the operation 110 of acquiring the process recipe may include receiving a process recipe generated from a generative model. The generative model may be an artificial intelligence neural network that generates new data (e.g., a text, image, audio, or video) based on a user input (e.g., voice input, text input, image input, or the like). The generative model may include, for example, at least one of a language model, a large language model (LLM), a large multimodal model (LMM), a foundation model (FM), and a multi-modal foundation model (MMFM). For example, the generative model may generate a process recipe for a particular purpose based on an input prompt. The electronic device performing the method of managing a process recipe may communicate with the generative model and receive a process recipe generated from the generative model.

The method of managing a process recipe may include an operation 120 of converting at least one step of the process recipe (a process step) to a corresponding step with individual equipment (an equipment step); the converting may be based on mapping information corresponding to the acquired process recipe.

An individual equipment may be a particular piece of equipment that executes at least one step of a process recipe. An individual equipment may be distinct according to various actual equipment pieces of information, for example, manufacturer, make, and/or model. For example, when the individual equipment includes the first equipment and second equipment, some process steps of the process recipe may be carried out by the first equipment, and other steps of the process recipe may be carried out by the second equipment. At least one step of the acquired process recipe may be changed to a an equipment step of the equipment recipe for the individual equipment, which can be executed on the individual equipment. For example, an equipment step for the individual equipment may include instructions for controlling the individual equipment. Such a recipe step may be specific to the individual equipment. So, for example, if another type/model/etc. of individual equipment is used, the control instructions may have nearly the same logic and yet may differ in ways that are specific to the other individual equipment.

Mapping information may be information for translating from a generalized process recipe to an equipment process recipe (or equipment process) for individual equipment, and may include, for example, (i) information for converting a generalized process recipe to an equipment-specific process recipe for individual equipment and/or (ii) information for converting an equipment process recipe specific to one individual equipment to an equipment process recipe specific to another individual equipment. For example, the mapping information may include information indicating a mapping relationship between steps in a generalized process recipe and steps in a recipe for individual equipment. For example, the mapping information may include information an equipment step (or multiple) of the equipment recipe of the first equipment an equipment recipe of an equipment recipe for the second equipment are each mapped to a first process step of the generalized process recipe. The generalized process recipe may also be referred to as a common process recipe.

For example, the mapping information may include mapping information corresponding to each individual equipment. For example, the mapping information may include (i) mapping information for conversion between a common process recipe and a process recipe corresponding to first equipment and (ii) mapping information for conversion between a common process recipe and a process recipe corresponding to second equipment. In sum, the mapping information may include associations between common steps/actions and corresponding equipment-specific steps/actions. In some cases, a common recipe step/action may map to multiple steps/actions of a specific equipment.

The converting operation 120 may include converting an action included in a step (although “step” and “action” are sometimes used synonymously, a step may have multiple actions; a single-action step may be an action) of the process recipe (also referred to as a process action) to an action corresponding to the individual equipment (also referred to as an equipment action) based on the mapping information (associations) corresponding to the process recipe. The mapping information may include action information for the individual equipment that is mapped to particular actions in the process recipe. Based on the mapping information, a first action (process step/action) included in the process recipe may be converted to a second action (equipment step/action) corresponding to the individual equipment. For example, a process action included in a step of the process recipe may be converted to an equipment action directing control of the individual equipment. For example, a process step/action of setting the pressure may be converted to a step/action that controls setting a pressure pump (which is an individual equipment). For example, a process action to inject a particular substance may be converted to an equipment action to open a particular valve in the individual equipment.

The converting operation 120 may include converting a parameter included in a process step (step of the process recipe) based on parameter conversion logic corresponding to the individual equipment to which the process step is mapped in the mapping information. Generally, the mapping information may include parameter conversion logic for conversion between process recipes and equipment recipes (recipes of individual equipment). For example, the process recipe may have an injection step that includes a process parameter for the amount of material injected. The mapping information may include, as part of an association between the injection process step and an individual equipment, process parameters and equipment parameters. The process parameters may be converted to the equipment parameters. For example, the conversion logic may include logic to convert a process parameter of an amount of material to an equipment parameter of a degree of valve opening. The conversion logic may be applied to the process parameter to convert it to a degree of opening of the valve of the individual equipment. That is, a process parameter x for the amount of material injected may be converted to a parameter y, which indicates a degree to which the valve is opened, and the converting may be done according to the parameter conversion logic.

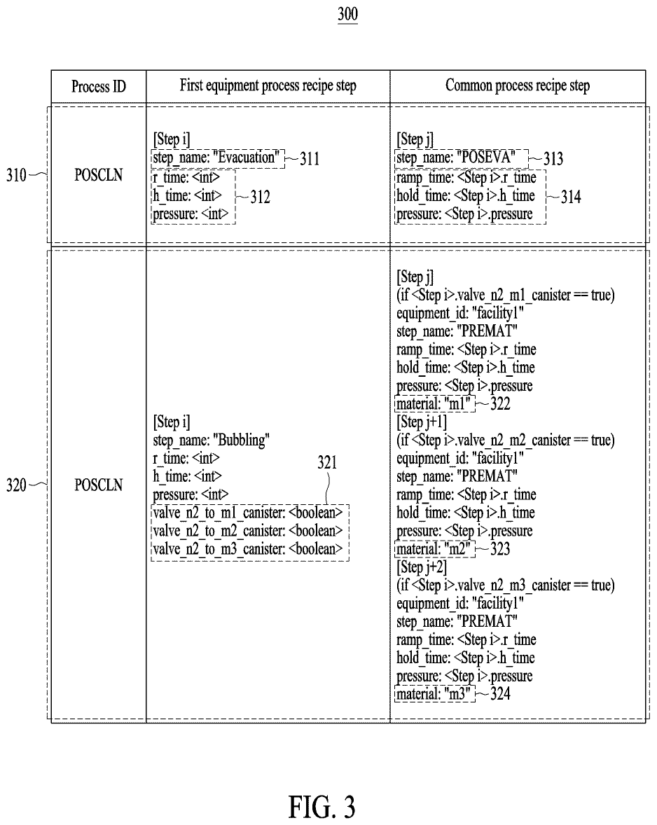

FIG. 3 illustrates an example of mapping information, according to one or more embodiments.

Referring to the example of FIG. 3, the mapping information may include a look-up table (LUT) 300 that stores conversion rules for conversion from process steps (steps of a common process recipe; right column) and equipment steps (steps of individual equipment, middle column). That is, the LUT 300 may include conversion rules for converting between (i) process steps of a common process recipe corresponding to a process ID and respectively corresponding (ii) equipment steps of a process recipe of first equipment. For example, referring to row 310 in which a process ID of the LUT 300 is “POSCLN”, a process step (of the process recipe, e.g., “[Step i]”) of the first equipment corresponding to the process ID “POSCLN” may include information 311 indicating a process action of “Evacuation” and may include associated process parameters 312. The process step of the first equipment process stop recipe corresponding to the process ID “POSCLN” may be converted to an action of “POSEVA” of the common process recipe step (e.g., “[Step j]”) of the recipe of the first equipment. The process parameters 312 corresponding to the process step of the recipe of the first equipment corresponding to the process ID “POSCLN” may be converted to equipment parameters 314 of the common process recipe step corresponding to the step of the common recipe. As another example, referring to row 320 in which the process ID of the LUT 300 is “PREMAT”, a process step of a recipe of the first equipment corresponding to the process ID “PREMAT” may include process information 321 indicating valve names. The process information 321 indicating the valve names may be converted to equipment information 322, 323, and 324 indicating material names in the steps of the common process recipe.

Regarding the example LUT 300, it may be noted that pieces of process information in the first equipment process recipe step column are referenced, akin to macros, in the mapped-to common steps of the common process recipe step column. For example, equipment parameters 314 include “ramp_time:<Step i>.r_time”. Here, “<Step i>.r_time” is a field/variable in the corresponding first equipment process parameters 312, and when a value for that parameter is known (e.g., when executing the converted equipment process), the value may be substituted into the corresponding common process recipe step parameter. In other words, the description of a common process recipe step may include a reference to a parameter of the corresponding first equipment process recipe step, which can be set when generating the common process/step or when executing the common process/step on equipment.

The method of managing a process recipe may include receiving mapping information mapping a process step of a process recipe to an equipment step of individual equipment, determining a validity of the mapping information based on specifications of the individual equipment, and updating the mapping information based on the determination of the validity. In other words, the mapping information may be input by a user, and the electronic device may determine the validity of the mapping information input by the user and store the mapping information determined to be valid. Here, determining the validity may involve checks such as applying tools to assure that references are valid, syntax is correct, logic has no errors, and so forth.

As an example, the updating of the mapping information may include adjusting (or adding to) the parameter conversion logic included in the mapping information based on the specifications of the individual equipment. As an example, the updating of the mapping information may include determining a constraint condition of the parameters based on the specifications of the individual equipment and adjusting the parameter conversion logic included in the mapping information based on the constraint condition.

A detailed method for determining the validity of the mapping information to store the received mapping information is described below.

Referring back to FIG. 1, the method of managing a process recipe may include an operation 130 of storing the converted step in correspondence with the individual equipment (e.g., in a database associated with the individual equipment). The converted step may be stored in a database corresponding to each piece of individual equipment. For example, a step converted for the first equipment may be stored in a database corresponding to the first equipment, and a step converted in response to the second equipment may be stored in a database corresponding to the second equipment.

Each piece of individual equipment may execute any of the steps stored in a database corresponding to that individual equipment. Each individual equipment may transmit, to the electronic device, an execution result of performing a step. The method of managing a process recipe may include outputting an execution result of performing the converted step of the individual equipment. As an example, the execution result may include a quantitative evaluation result of a material generated by the process recipe (e.g., an amount of produced material). As an example, the execution result may include a quantitative evaluation result of a device (or semiconductor device) or thin film generated by a CVD process recipe. The execution result may be output to the electronic device or a user's terminal communicating with the electronic device through an interface.

The method of managing a process recipe may include updating the process recipe based on the execution result of the converted step of the individual equipment. For example, when the execution result of a step is different from a target result, a portion of the steps of the process recipe may be updated. For example, the execution result of a step may be provided to the electronic device or a user's terminal communicating with the electronic device, and the user may modify the process recipe through the interface. Each step in the modified process recipe may be converted to a step of individual equipment and executed on the individual equipment. Since the common process recipe is converted to a process recipe corresponding to each piece of individual equipment, the user may control the steps of a target process recipe to be executed on each piece of individual equipment by generating or modifying only the common process recipe without having to generate a recipe corresponding to each piece of individual equipment. In other words, since the common process recipe may be an abstract (equipment-neutral) process that can be converted to equipment-specific steps for respective individual pieces of equipment, the execution of the process may be controlled such that the modified abstract process recipe is extended to modified executions on the individual pieces of equipment by only having to modify/update the common process recipe (and then convert the same to the equipment steps), that is to say, without regard for which particular pieces of individual equipment will execute the step of the process recipe.

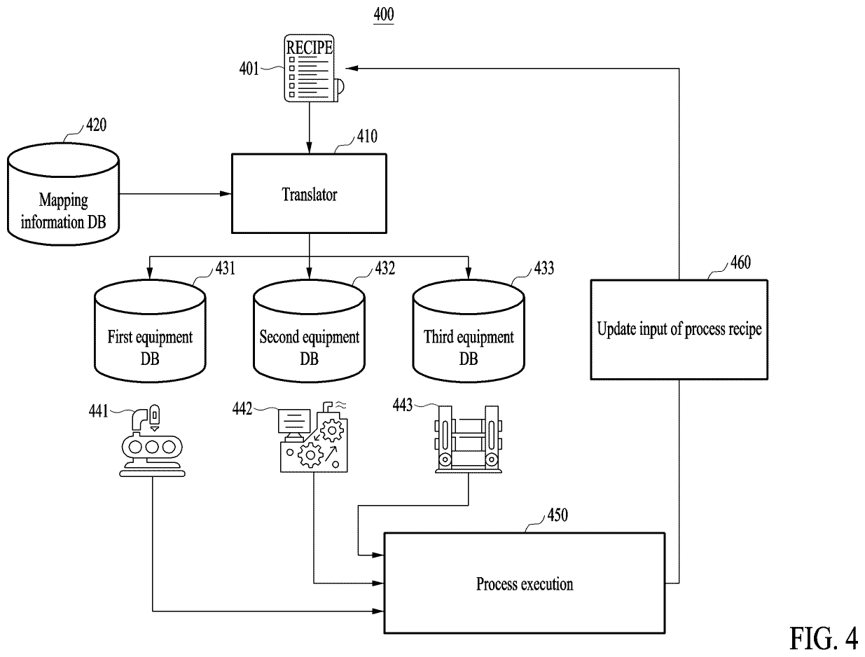

FIG. 4 illustrates an example of a system for managing a process recipe, according to one or more embodiments.

Referring to FIG. 4, a system for managing a process recipe may include a translator 410. The translator 410 may be executed by an electronic device that performs the method of managing a process recipe described above.

The translator 410 may receive a process recipe 401. The translator 410 may convert a common process step of the received process recipe 401 to equipment steps respectively corresponding to pieces of individual equipment.

For example, the translator 410 may convert some process steps of the process recipe 401 to equipment steps corresponding to first equipment 441, and may perform this converting based on mapping information stored in a mapping information database (DB) 420. A converted equipment step corresponding to the first equipment may be stored in a first equipment DB 431 that stores an equipment recipe corresponding to the first equipment 441. The equipment step(s) of the equipment-specific process recipe stored in the first equipment DB 431 may be executed by the first equipment 441. For example, the first equipment may have a processor, controller, or the like that is configured to parse and interpret the equipment step/recipe and control the first equipment accordingly.

For example, the translator 410 may convert some process steps of the process recipe 401 to equipment steps corresponding to second equipment 442, and may do so based on mapping information stored in the mapping information DB 420. A converted step corresponding to the second equipment 442 may be stored in a second equipment DB 432 that stores an equipment recipe corresponding to the second equipment 441. The converted step(s) of the process recipe stored in the second equipment DB 432 may be executed by the second equipment 442.

For example, the translator 410 may convert some process steps of the process recipe 401 to equipment steps corresponding to third equipment 443 based on mapping information stored in the mapping information DB 420 (mapping information that is specific to the third equipment 443). A converted process step corresponding to the third equipment 443 may be stored in a third equipment DB 433 that stores an equipment process recipe corresponding to the third equipment 443. The converted step(s) of the process recipe stored in the third equipment DB 433 may be executed by the third equipment 443.

Based on results of process execution 450 by the first equipment 441, the second equipment 442, and the third equipment 443, an update input 460 of the process recipe may be received. A result of the process execution 450 may be output to an electronic device or a user's terminal communicating with the electronic device, through an interface. The update input 460 of the process recipe may be received from an electronic device or a user's terminal communicating with the electronic device, through an interface. For example, the update input 460 of the process recipe might, for example, change a type of a material injected in some steps of the process recipe, change an action of some steps of the process recipe, and/or change a value of a parameter (e.g., pressure, temperature, or the like) of some steps of the process recipe.

The process recipe 401 may be updated based on the update input 460 of the process recipe, and each step of the updated process recipe may be converted to steps of respective pieces of individual equipment such as the first equipment 441, the second equipment 442, and the third equipment 443 by the translator 410 (i.e., whichever pieces of equipment are mapped to the process steps).

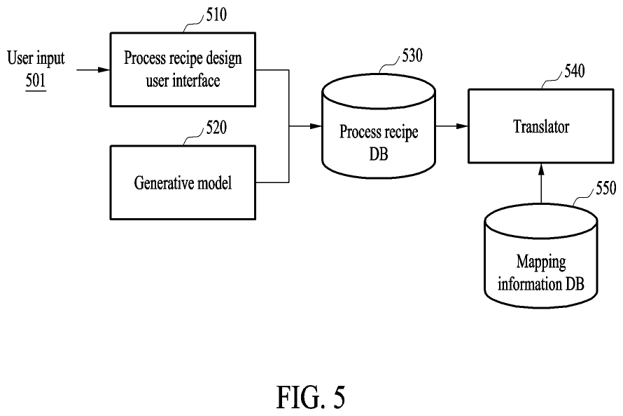

FIG. 5 illustrates an example of an operation of acquiring a process recipe, according to one or more embodiments.

Referring to FIG. 5, a process recipe may be received from a user input 501 through a user interface (hereinafter, process recipe design user interface) 510 for process recipe design, as a non-limiting example (the process recipe may come from any source). A user may input a process recipe through the process recipe design user interface 510. The process recipe input by the user may be stored in a process recipe DB 530.

The process recipe may include data generated from a generative model 520. The process recipe generated from the generative model 520 may be stored in the process recipe DB 530.

A translator 540 may correspond to the translator 410 of FIG. 4. The translator 540 may perform translation for a process recipe stored in the process recipe DB 530. The translator 540 may convert a process step of a process recipe to an equipment step of a process recipe corresponding to individual equipment based on mapping information stored in a mapping information DB 550.

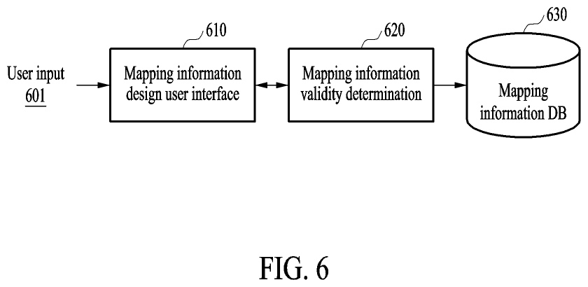

FIG. 6 illustrates an example of a process of building a mapping information DB, according to one or more embodiments.

Referring to FIG. 6, mapping information may be received from a user input 601 through a user interface (hereinafter, mapping information design user interface) 610 for mapping information design. A user may input mapping information mapping between a process step of a common process recipe and an equipment step of individual equipment through the mapping information design user interface 610. An electronic device performing the method of managing a process recipe may receive the mapping information.

A validity determination operation 620 may be performed on the mapping information input by the user. The validity determination operation 620 for the input mapping information may be performed in the electronic device. The electronic device may determine the validity of the input mapping information based on specifications of the individual equipment.

For example, the validity of an action of individual equipment included in the mapping information may be determined based on the specifications of that individual equipment. Based on the specifications of the individual equipment, when an action of the individual equipment included in the mapping information is an action not supported by the individual equipment, the mapping information may be determined to be invalid.

For example, the validity of a parameter value corresponding to individual equipment included in the mapping information may be determined based on constraint conditions indicated by the specifications of the individual equipment. For example, when the specifications of the individual equipment include a maximum value for a particular parameter, the mapping information may be determined to be invalid when a parameter value included in the mapping information exceeds the maximum value. The parameter value may be adjusted to a value less than the maximum value indicated by the specifications of the individual equipment.

For example, the electronic device may determine the validity of the parameter conversion logic included in the mapping information based on the specifications of the individual equipment. When a parameter value of individual equipment converted according to the parameter conversion logic does not meet a constraint condition indicated by the specifications of the individual equipment, the parameter conversion logic may be determined to be invalid. The parameter conversion logic may be adjusted so that a parameter value of individual equipment is converted to a value that meets the constraint condition indicated by the specifications of the individual equipment.

As a result of performing the validity determination operation 620 on the input mapping information, the mapping information determined to be valid may be stored in a mapping information DB 630. The electronic device may convert a step of an input process recipe to a step of individual equipment based on the mapping information stored in the mapping information DB 630. For example, the process recipe stored in the mapping information DB 630 may be used when the process recipe is converted to an equipment recipe for an individual equipment by the translator 410 of FIG. 4 or the translator 540 of FIG. 5.

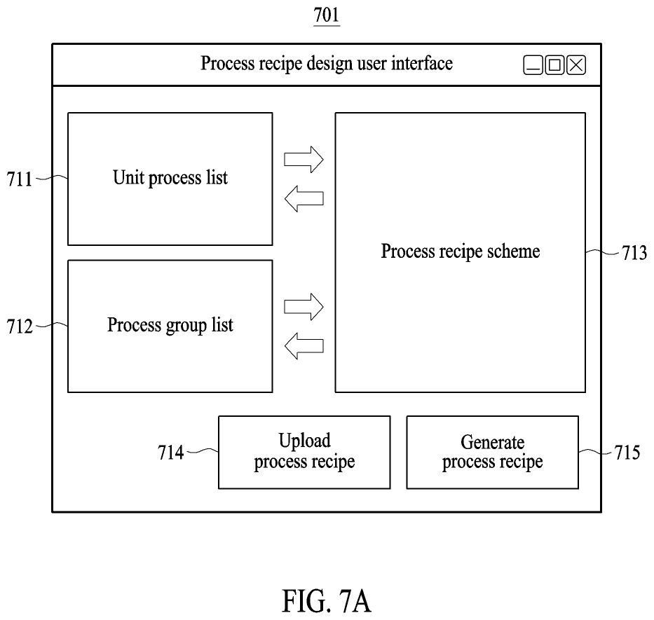

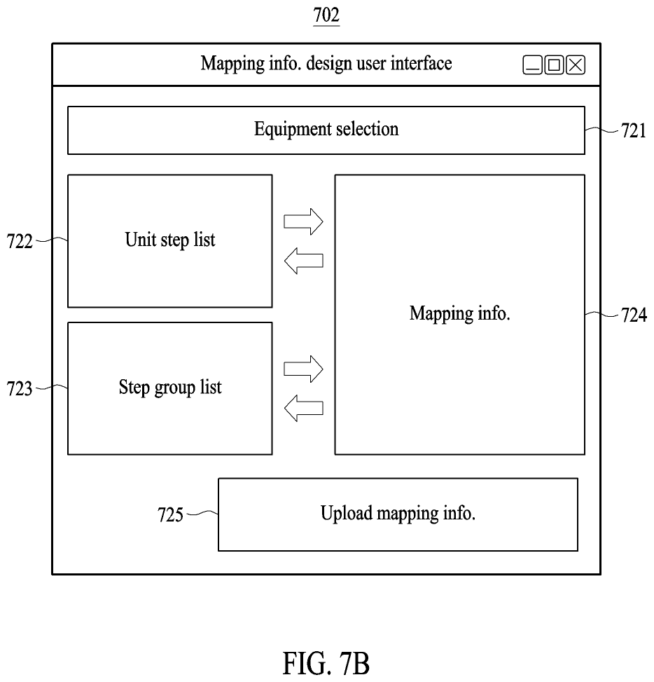

FIGS. 7A and 7B illustrate an example of a screen of a user interface, according to one or more embodiments.

A screen 701 of FIG. 7A and a screen 702 of FIG. 7B may correspond to a screen output through an input/output device (e.g., a display) of an electronic device that performs a method of managing a process recipe, or a screen output to a user terminal that communicates with the electronic device.

The screen 701 of FIG. 7A may correspond to a user interface screen for designing a process recipe. Referring to the screen 701, a list of single processes divided into particular units that may be included in a process recipe may be displayed in a “unit process list” window 711. For example, a list of processes of a particular unit, such as “cleaning,” “growth,” or “cooling,” may be displayed through the “unit process list” window 711.

A user may select a single process of a process recipe from the “unit process list” window 711 and add the selected single process to a “process recipe scheme” window 713, or remove a single process already added to the “process recipe scheme” window 713.

A list of sets of processes that may be included in a process recipe may be displayed in a “process group list” window 712. For example, a list of pre-processes, growth processes, and post-processes, which are a set of a plurality of processes, may be displayed through the “process group list” window 712.

The user may select a set of processes from the “process group list” window 712 and add the selected set of processes to the “process recipe scheme” window 713, or remove a set of processes already added to the “process recipe scheme” window 713.

The “process recipe scheme” window 713 may be configured for designing a process recipe. A process recipe may include one or more steps corresponding to item(s) selected in at least one of the “unit process list” window 711 and the “process group list” window 712, and each step may include action(s) and/or parameter(s). For example, a process order of the item(s) selected in at least one of the “unit process list” window 711 and the “process group list” window 712 may be input through the “process recipe scheme” window 713. For example, process conditions (e.g., parameters), detailed settings, and the like corresponding to the items selected in at least one of the “unit process list” window 711 and the “process group list” window 712 may be input through the “process recipe scheme” window 713.

A process recipe designed through the “process recipe scheme” window 713 may be uploaded to a process recipe DB by selecting a button 714 requesting an upload.

The generation of a process recipe may be requested of a generative model by an input selecting a button 715 requesting the generation of the process recipe. For example, by an input selecting the button 715, the generation of a process recipe corresponding to a process recipe designed through the “process recipe scheme” window 713 in the generative model may be requested. The process recipe generated from the generative model may be stored in the process recipe DB.

The screen 702 of FIG. 7B may correspond to a screen of a user interface for designing mapping information. Referring to the screen 702, individual equipment to which mapping information input through the interface is to be applied may be determined by an input selecting an equipment selection button 721. Mapping information input through the interface may correspond to mapping information between a step in a process recipe of selected individual equipment and a step in a common process recipe.

A list of single steps divided into particular units and included in a process recipe may be displayed in a “unit step list” window 722. A list of sets of a plurality of steps included in a process recipe may be displayed in a “step group list” window 723.

A user may input mapping information for an item displayed in the “unit step list” window 722 through a “mapping info.” input window 724. The user may input mapping information for an item displayed in the “step group list” window 723 through the “mapping info.” input window 724.

The mapping information input through the “mapping info.” input window 724 may be transmitted to the electronic device responsive to an input selecting a button 725 requesting an upload. The electronic device may perform a validity determination on the uploaded mapping information. The electronic device may perform the validity determination on the uploaded mapping information based on specifications of the selected individual equipment. The electronic device may store the mapping information determined to be valid in a mapping information DB. The mapping information stored in the mapping information DB may be used when a step of a process recipe corresponding to individual equipment in the electronic device is converted to a step of a common process recipe, or when a step of a common process recipe is converted to a step of a process recipe corresponding to individual equipment.

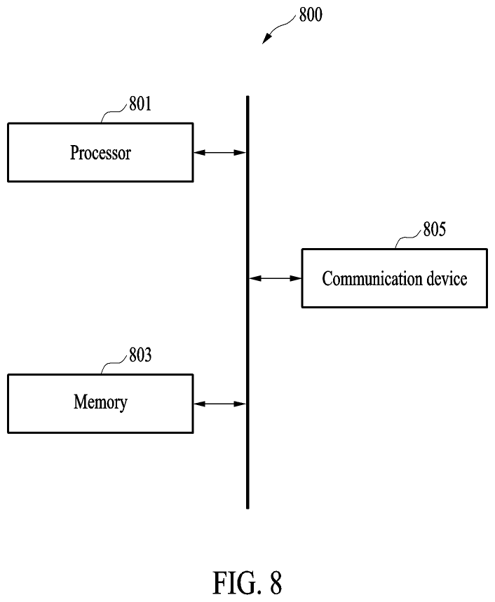

FIG. 8 illustrates an example of a configuration of an electronic device, according to one or more embodiments.

Referring to FIG. 8, an electronic device 800 may include a processor 801, a memory 803, and a communication device 805. The electronic device 800 may include an apparatus for performing the method of managing a process recipe described above with reference to FIGS. 1 to 6. For example, the electronic device 800 may be a server or a terminal (e.g., a personal computer (PC), a tablet, a mobile phone, or a wearable device).

The processor 801 may perform at least one operation of the method of managing a process recipe described above with reference to FIGS. 1 to 6. For example, the processor 801 may perform at least one of the operations of acquiring a process recipe, converting at least one step of the process recipe to a step corresponding to individual equipment based on mapping information corresponding to the process recipe, and storing the converted step in correspondence with the individual equipment. In practice, the processor 801 may be one or more processors.

The memory 803 may be a volatile memory or a non-volatile memory and may store data related to the method of managing a process recipe described above with reference to FIGS. 1 to 6. For example, the memory 803 may store data generated during the process of performing the method of managing a process recipe or data required to perform the method of managing a process recipe. For example, the memory 803 may store at least one of a step of a process recipe converted corresponding to individual equipment, a process recipe, and mapping information.

The communication device 805 may provide a function for the electronic device 800 to communicate with another electronic device or another server through a network. In other words, the electronic device 800 may be connected to an external device (e.g., a terminal of a user, a server, or a network) through the communication device 805 and may exchange data with the external device.

The memory 803 may not be a component of the electronic device 800 but may be included in an external device accessible by the electronic device 800. In this case, the electronic device 800 may receive data stored in the memory 803 included in the external device and transmit data to be stored in the memory 803 through the communication device 805. For example, the memory 803 may include a DB (e.g., the first equipment DB 431, the second equipment DB 432, or the third equipment DB 433 of FIG. 4) corresponding to individual equipment that stores a step of a process recipe converted corresponding to the individual equipment. For example, the memory 803 may include a process recipe DB (e.g., the process recipe DB 530 of FIG. 5). For example, the memory 803 may include a mapping information DB (e.g., the mapping information DB 420 of FIG. 4, the mapping information DB 550 of FIG. 5, or the mapping information DB 630 of FIG. 6).

The memory 803 may store a program implementing the method of managing a process recipe described above with reference to FIGS. 1 to 6. The processor 801 may execute a program stored in the memory 803 and may control the electronic device 800. Code of the program executed by the processor 801 may be stored in the memory 803.

For example, the memory 803 may store instruction(s). When the instructions are executed by one or more processors 801, the instructions may cause the electronic device 800 to acquire a process recipe, convert at least one step of the process recipe to a step corresponding to individual equipment based on mapping information corresponding to the process recipe, and store the converted step in correspondence with the individual equipment.

The electronic device 800 may further include other components not shown in the drawings. For example, the electronic device 800 may further include an input/output interface including an input device and an output device for interfacing with the communication device 805. In addition, for example, the electronic device 800 may further include other components such as a transceiver, various sensors, and a DB.

The computing apparatuses, the electronic devices, the processors, the memories, the displays, the equipment, the information output system and hardware, the storage devices, and other apparatuses, devices, units, modules, and components described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of managing a process recipe of a production process, the method performed by a computing device and comprising:
acquiring a process recipe, wherein the process recipe comprises process steps that express respective steps of the production process independent of any individual equipment;
converting a process step, among the process steps, to an equipment step corresponding to an individual equipment, wherein the converting is based on mapping information corresponding to the process recipe, and wherein the equipment step expresses the process step with reference to the individual equipment; and
storing the equipment step in association with the individual equipment.

2. The method of claim 1, wherein the process recipe is a chemical vapor deposition (CVD) process recipe.

3. The method of claim 1, wherein the converting comprises converting an action included in the process step to an equipment action corresponding to the individual equipment, and wherein the converting is based on the mapping information corresponding to the process recipe.

4. The method of claim 1, wherein the converting comprises converting a parameter included in the process step based on parameter conversion logic corresponding to the individual equipment included in the mapping information.

5. The method of claim 1, further comprising:
receiving mapping information of the process step of the process recipe and the equipment step of the individual equipment;
determining a validity of the mapping information based on a specification of the individual equipment; and
updating the mapping information based on the determination of the validity.

6. The method of claim 5, wherein the updating of the mapping information comprises adjusting parameter conversion logic included in the mapping information based on the specification of the individual equipment.

7. The method of claim 5, wherein the updating of the mapping information comprises:
determining a constraint condition of a parameter based on the specification of the individual equipment; and
adjusting parameter conversion logic included in the mapping information based on the constraint condition.

8. The method of claim 1, wherein the equipment step is performed in the individual equipment.

9. The method of claim 1, further comprising:
outputting an execution result of the converted step of the individual equipment.

10. The method of claim 1, further comprising:
updating the process recipe based on the execution result of the equipment step of the individual equipment.

11. The method of claim 1, wherein the acquiring of the process recipe comprises receiving an input of the process recipe from a user.

12. The method of claim 1, wherein the process recipe is generated by a generative model.

13. A non-transitory computer-readable storage medium storing instructions that, when executed by one or more processors, cause the one or more processors to:
acquire a process recipe, wherein the process recipe comprises process steps that express respective steps of the production process independent of any individual equipment;
convert a process step, among the process steps, to an equipment step corresponding to an individual equipment, wherein the converting is based on mapping information corresponding to the process recipe, and wherein the equipment step expresses the process step with reference to the individual equipment; and
store the equipment step in association with the individual equipment.

14. An electronic device, comprising:
one or more processors; and
a memory storing instructions that, when executed by the one or more processors, cause the electronic device to:
acquire a process recipe, wherein the process recipe comprises process steps that express respective steps of a manufacturing process independent of any individual equipment;
convert a process step, among the process steps, to an equipment step corresponding to an individual equipment based on mapping information corresponding to the process recipe, and wherein the equipment step expresses the process step with reference to the individual equipment; and
store the equipment step in association with the individual equipment.

15. The electronic device of claim 14, wherein the process recipe is a CVD process recipe.

16. The electronic device of claim 14, wherein the converting comprises converting an action included in the process step to an equipment action corresponding to the individual equipment, and wherein the converting is based on the mapping information corresponding to the process recipe.

17. The electronic device of claim 14, wherein the converting comprises converting a parameter included in the process step based on parameter conversion logic corresponding to the individual equipment included in the mapping information.

18. The electronic device of claim 14, wherein the instructions are further configured to cause the electronic device to:
receive mapping information of the process step of the process recipe and the equipment step of the individual equipment;
determine a validity of the mapping information based on a specification of the individual equipment; and
update the mapping information based on the determination of the validity.

19. The electronic device of claim 18, wherein the updating of the mapping information comprises adjusting parameter conversion logic included in the mapping information based on the specification of the individual equipment.

20. The electronic device of claim 18, wherein the updating of the mapping information comprises:
determining a constraint condition of a parameter based on the specification of the individual equipment; and
adjusting parameter conversion logic included in the mapping information based on the constraint condition.
